(19) United States
(12) Patent Application Publication
(10) Pub. No.: US 2010/0151176 A1
(43) Pub. Date: Jun. 17, 2010

(54) Waterproof Softshell Construction

(75) Inventors: John Thiet Ly, Richmond, CA (US); Neil Tappan Munro, San Francisco, CA (US); Kin Siang Kong Chan, Hercules, CA (US)

Correspondence Address: KENYON & KENYON LLP, 1500 K STREET N.W., SUITE 700, WASHINGTON, DC, 20005, US

(73) Assignee: The North Face Apparel Corporation, Wilmington, DE (US)

(21) Appl. No.: 12/337,255

(22) Filed: Dec. 17, 2008

(51) Int. Cl. B32B 3/06; B32B 37/06

(52) U.S. Cl. 428/61; 156/73.4

(57) ABSTRACT

The present invention provides a waterproof softshell construction having a face fabric layer, a laminate layer, and a back layer. The three layers are joined at a joint seam using a sonic welder. The joint seam is covered by a seam seal, the seam seal including face fabric tape, having a first major surface and a second major surface, and stretch adhesive located on at least the first major surface of the face fabric tape. The present invention also provides a method for preparing a waterproof softshell construction. The present invention further provides a waterproof softshell construction prepared by a process including the steps of joining a face fabric layer, a laminate layer, and a backer layer at a joint seam by sonic welding and attaching face fabric tape to the joint seam using stretch adhesive.

### TECHNICAL FIELD

The present invention generally relates to waterproof, breathable fabrics, such as those used in the garment industry.

### BACKGROUND

Waterproof, breathable materials—particularly those used for constructing various types of apparel—are commonplace in the art. One such example is the waterproof laminate described in U.S. Pat. No. 4,194,041 issued to Gore et al. (hereinafter the “Gore patent”), the entirety of which is incorporated herein by reference. As used in the garment industry, these materials allow a wearer to be kept dry during the rain, for example, while still allowing for evaporation of perspiration. These materials typically comprise two or more laminates of different materials joined together to form a single, multi-layer composite material. In order to remain waterproof, these laminates require a waterproof seam. A common method for joining two laminates of a composite material together at a waterproof seam is known as skiving.

Skiving is a technique often used to prepare the edges of two laminates to be joined. The process entails selectively removing material from the thickness of the laminates in order to join the two laminates more easily. This removal may be accomplished via cutting, grinding, sanding, or other similar processes. In addition, various types of skiving machines are commercially available specifically for this purpose.

However, there is a need for an alternative to the skiving process for joining two or more layers together to create a waterproof seam.

### SUMMARY

The present invention generally relates to multi-layer waterproof softshell materials. In certain embodiments, a waterproof softshell construction includes a face fabric layer, a laminate layer, and a backer layer. A waterproof softshell construction of these embodiments also includes at least one joint seam defined by a point at which the face fabric layer, the laminate layer, and the backer layer are joined together. The at least one joint seam is created using a sonic welder. A waterproof softshell construction of these embodiments also includes at least one seam seal at least partially covering the at least one joint seam. The at least one seam seal of these embodiments includes face fabric tape (having a first major surface and a second major surface) and stretch adhesive located on at least the first major surface of the tape.

The present invention also provides a method of preparing a waterproof softshell construction. In certain embodiments, the method includes the steps of joining a face fabric layer, a laminate layer, and a backer layer at a joint seam using a sonic welder. The method further includes attaching face fabric tape to the joint seam using stretch adhesive.

The present invention additionally provides a waterproof softshell construction prepared by a process including the steps of joining a face fabric layer, a laminate layer, and a backer layer at a joint seam by sonic welding. The waterproof softshell construction is further prepared by attaching face fabric tape to the joint seam using a stretch adhesive.

The invention may be embodied in numerous devices and through numerous methods and systems. The following detailed description, taken in conjunction with the annexed drawings, discloses examples of the invention. Other embodiments, which incorporate some, all or more of the features as taught herein, are also possible.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is an isometric view of a waterproof softshell construction in accordance with an embodiment of the present invention, in which the three layers are shown separated from one another;

FIG. 2 is an isometric view of the waterproof softshell construction of FIG. 1, in which the three layers are shown stacked together;

FIG. 3 is a top plan view of two pieces of a waterproof softshell construction in an embodiment of the present invention, wherein the two pieces are connected via a joint seam;

FIG. 4A is a top plan view of two pieces of a waterproof softshell construction in an embodiment of the present invention, wherein the two pieces are connected via an angled joint seam;

FIG. 4B is a top plan view of two pieces of a waterproof softshell construction in an embodiment of the present invention, wherein the two pieces are connected via a curved joint seam;

FIG. 5A is an isometric view of the waterproof softshell construction pieces of FIG. 3 having a seam seal partially placed on top of the joint seam; and

FIG. 5B is a top plan view of the waterproof softshell construction pieces of FIG. 5A after the seam seal has been placed on the joint seam.

### DETAILED DESCRIPTION OF THE INVENTION

The present invention generally relates to a waterproof softshell construction. By “softshell” it is meant that a construction is a water-resistant synthetic fabric that is stretchable (and, in certain embodiments, preferably soft to the touch). A waterproof softshell construction of the present invention may be used to fabricate a wide variety of products. Non-limiting examples include outdoor products (such as tents, tarps, bags, etc.) and garments (such as jackets, gloves, wetsuits, and other types of apparel).

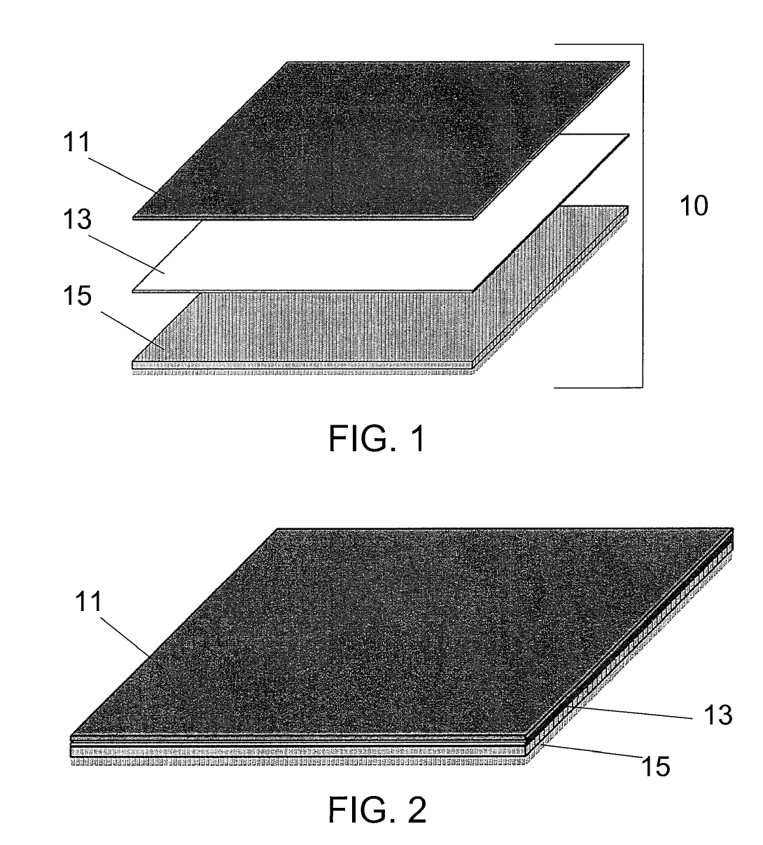

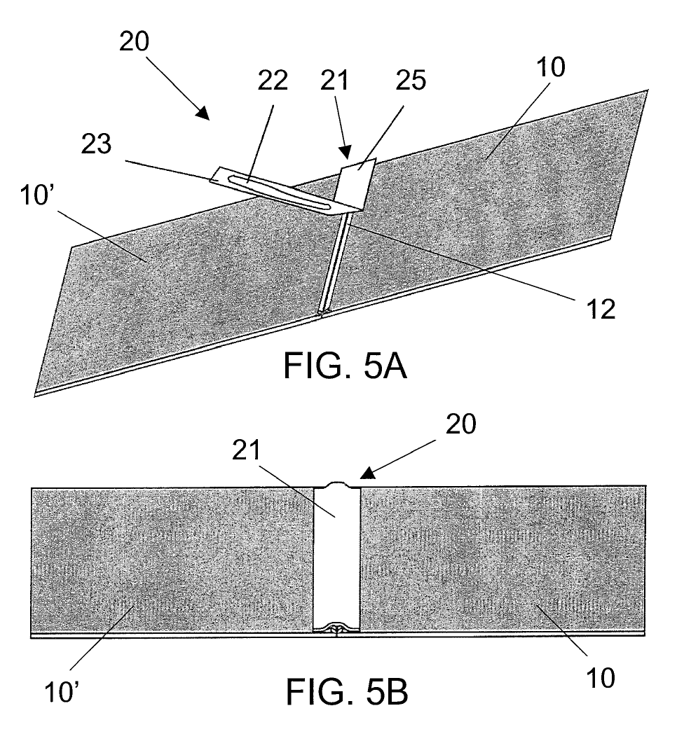

Turning to FIGS. 1 and 2, in certain embodiments a waterproof softshell construction 10 comprises a face fabric layer 11, a laminate layer 13, and a backer layer 15. Although the order of the layers shown in these figures is preferable, the layers need not be in the order shown in FIGS. 1 and 2 in all embodiments. For example, in certain embodiments the face fabric layer could be located between the laminate layer and the backer layer. Turning to FIG. 5A, a waterproof softshell construction further includes a joint seam 12 and a seam seal 20. Seam seal 20 includes face fabric tape 21 (having a first major surface 23 and a second major surface 25) and stretch adhesive 22.

A face fabric layer in accordance with certain embodiments of the present invention may be any water-resistant, stretchable synthetic fabric. A face fabric layer in accordance with certain embodiments may also be made of any other stretchable, water-resistant or water-repellant fabric, material, or combination thereof known in the art and suitable for use as an outer layer of a multi-layer construction. Non-limiting examples of suitable material for the face fabric layer include a polyester nylon elastine fabric and the waterproof laminate described in the Gore patent. Preferably, the face fabric layer is not located between the other two layers and has an exposed major surface, as shown by layer 11 in FIGS. 1 and 2, for example. In certain embodiments, the exposed major surface of the face fabric layer is the outer surface of a garment.

A waterproof softshell construction in accordance with the present invention also includes a laminate layer. A laminate layer in accordance with certain embodiments of the present invention may be any water-resistant, breathable stretch laminate known in the art. Non-limiting examples of suitable material for the laminate layer include the HyVent™ material produced by The North Face Apparel Corp. (“HYVENT” is a trademark of the North Face Apparel Corp.) Preferably, the laminate layer is located between the other two layers, as shown by layer 13 in FIGS. 1 and 2, for example.

A waterproof softshell construction in accordance with the present invention further includes a backer layer. A backer layer in accordance with certain embodiments of the present invention may be any knit backer or other fabric suitable for use as an inner layer of a multi-layer construction. Non-limiting examples of suitable material for the backer layer include a brush backer or a warp knit tricot backer. Preferably, the backer layer is not located between the other two layers and has an exposed major surface, as shown by layer 15 in FIGS. 1 and 2, for example. In certain embodiments, the exposed major surface of the backer layer is the inner surface of a garment and in contact with a wearer's skin when worn.

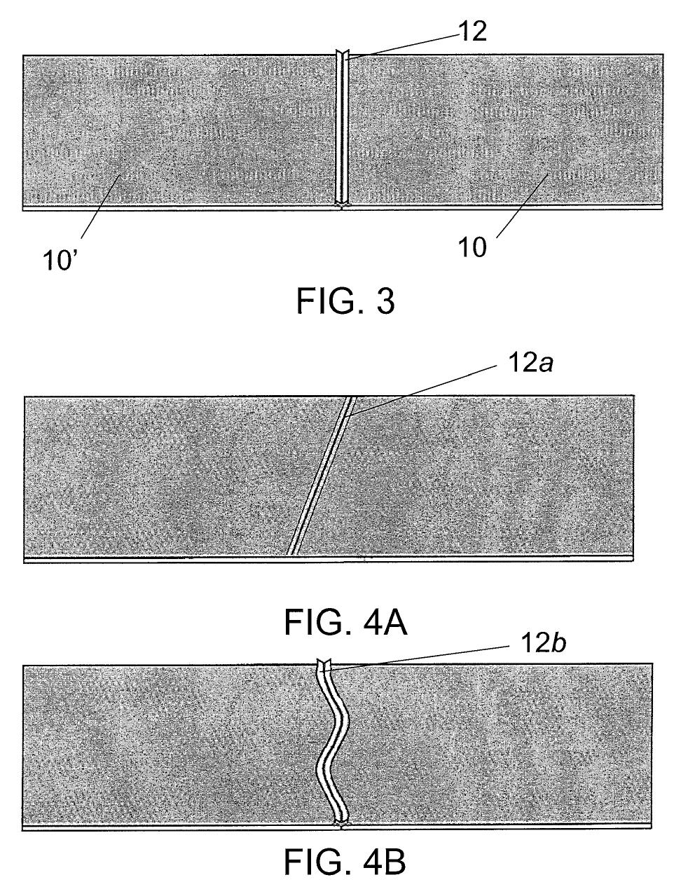

A joint seam in accordance with certain embodiments acts to connect the various layers of the present invention together. In certain embodiments, such as the embodiment shown in FIG. 3, a joint seam 12 connects the various layers of waterproof softshell construction 10. A joint seam in accordance with the present invention may be used to connect several pieces of composite material together, as shown by seam 12 joining construction 10 to construction 10′. A joint seam need not extend along the entire width of a construction (as shown in FIG. 3) but may extend along only a portion of a construction's width. In addition, a joint seam need not extend parallel to the width of a construction but may extend at an angle (as shown by seam 12a in FIG. 4A), along a curve (as shown by seam 12b in FIG. 4B), or numerous other configurations not shown here. A joint seam may be defined by a point at which the face fabric layer, the laminate layer, and the backer layer are joined together by sonic welding. A single waterproof softshell construction may have several joint seams, and one or more joint seams may be used to connect several constructions. Additionally, a joint seam in certain embodiments may simply join the various layers of the present invention together on a single construction without linking together two or more separate constructions.

A joint seam of the present invention is created using a sonic welder and may be defined by any point at which two or more layers are joined together, such as the location of seam 12 in FIG. 5A where a face fabric layer, a laminate layer, and a backer layer are joined. As used herein, “sonic welding” refers to the process of joining two or more components together using ultrasonic frequencies. As used herein, a “sonic welder” refers to any device capable of carrying out the process of sonic welding. Any method for sonic or ultrasonic welding suitable for use on the fabrics described herein and known to those of skill in the art may be used to create the joint seam of the present invention. In certain embodiments, a joint seam has a thickness of between about 1-2 mm. However, the thickness may be larger or smaller as needed. Unlike the typical skiving process, the use of a sonic welder does not require that material be selectively removed from the thickness of the layers to be joined together, thus resulting in more efficient production process.

A seam seal of the present invention includes face fabric tape and stretch adhesive. A seam seal in accordance with certain embodiments of the present invention is configured to at least partially cover a joint seam. In certain embodiments such as the embodiment shown in FIG. 5A, a seam seal 20 comprises face fabric tape 21, having a first major surface 23 and a second major surface 25, and a stretch adhesive 22. Preferably, a seam seal covers a substantial portion, or all of, a joint seam, as show by seam seal 20 in FIG. 5B. A seam seal in accordance with certain embodiments may be located on a major surface of a backer layer, a face fabric layer, or both. In addition, a seam seal in accordance with certain embodiments may be located on any other layer having an exposed major surface.

Face fabric tape in accordance with certain embodiments of the present invention may be made of any material known in the art and suitable for covering a joint seam. Non-limiting examples include polyester and elastane (e.g., such as a 98% polyester and 2% elastane composition). The face fabric tape may also be made from any material suitable for use as a face fabric layer, as described above. The face fabric tape may comprise any configuration and/or placement suitable for the needs of a particular application. Accordingly, the face fabric tape may be of a broad range of sizes and shapes as necessary in order to form an effective, waterproof seam seal.

Stretch adhesive in accordance with certain embodiments of the present invention may be any adhesive known in the art and of suitable strength for holding together several layers of fabric or other garment material. As shown in FIG. 5A, in certain embodiments stretch adhesive 22 is applied to a first major surface 23 of face fabric tape 21. However, the stretch adhesive may also be applied to other surfaces of the face fabric tape, the joint seam itself, or a surface of any of the layers described above. The stretch adhesive may occupy as little or as much of a surface as needed to effectively hold together the various layers of a multi-layer construction. Non-limiting examples of suitable stretch adhesives include thermoplastic polyurethane and polyether urethane hot melts. In certain embodiments, the stretch adhesive provides strength to the construction and aids in holding the multiple layers together. Accordingly, any adhesive known in the art suitable for this goal may be used. In certain embodiments, the stretch adhesive may be added to face fabric tape to form a seam seal. In other embodiments, the stretch adhesive is manufactured as part of the face fabric tape, similar to duct tape or other commonly used adhesive tapes.

Several waterproof softshell constructions may be joined together to form various products, such as jackets, wetsuits, or other garments. In addition, several constructions may be joined to form various outdoor products, such as tents, tarps, or bags. (Alternatively, a single waterproof softshell construction may be used to form all or a portion of these products.) The constructions comprising these products need not be the same size, shape, or configuration. Preferably, each seam in such a product is a joint seam formed by sonic welding as described above.

The present invention also provides a method of preparing a waterproof softshell construction. A method in accordance with certain embodiments includes the steps of joining a face fabric layer, a laminate layer, and a backer layer at a joint seam using a sonic welder. The method further includes attaching face fabric tape to the joint seam using stretch adhesive. In certain embodiments, a method may include creating several joint seams using a sonic welder on one or more waterproof softshell constructions. Additionally, in certain embodiments a method may include attaching several pieces of face fabric tape and stretch adhesive to one or more joint seams. A suitable amount of stretch adhesive may be applied to the face fabric tape, to the joint seam, or both, as needed. Any of the materials referred to above for the face fabric layer, laminate layer, backer layer, face fabric tape, and stretch adhesive may be used in accordance with this method.

The present invention additionally provides a waterproof softshell construction prepared by a process including the steps of joining a face fabric layer, a laminate layer, and a backer layer at a joint seam using a sonic welder and attaching face fabric tape to the joint seam using stretch adhesive. Any of the materials referred to above for the face fabric layer, laminate layer, backer layer, face fabric tape, and stretch adhesive may be used in accordance with the process. Additionally, any of the techniques described or referred to above may be used in accordance with this process.

While various embodiments have been described, other embodiments are plausible. It should be understood that the foregoing descriptions of various examples of a waterproof softshell construction are not intended to be limiting, and any number of modifications, combinations, and alternatives of the examples may be employed to facilitate the effectiveness of constructing a breathable, waterproof material using a sonic welder.

The examples described herein are merely illustrative, as numerous other embodiments may be implemented without departing from the spirit and scope of the exemplary embodiments of the present invention. Moreover, while certain features of the invention may be shown on only certain embodiments or configurations, these features may be exchanged, added, and removed from and between the various embodiments or configurations while remaining within the scope of the invention. Likewise, methods described and disclosed may also be performed in various sequences, with some or all of the disclosed steps being performed in a different order than described while still remaining within the spirit and scope of the present invention.

What is claimed is:

1. A waterproof softshell construction, comprising:
a face fabric layer;
a laminate layer;
a backer layer;
at least one joint seam defined by a point at which the face fabric layer, the laminate layer, and the backer layer are joined together; and
at least one seam seal at least partially covering the at least one joint seam, comprising:
face fabric tape having a first major surface and a second major surface; and
stretch adhesive located on at least the first major surface of the tape;
wherein the at least one joint seam is created using a sonic welder.

2. The construction of claim 1, wherein the face fabric layer is a polyester nylon elastine stretch fabric.

3. The construction of claim 1, wherein the laminate layer is a stretch laminate.

4. The construction of claim 1, wherein the backer layer is a tricot warp knit backer.

5. The construction of claim 1, wherein the at least one joint seam has a thickness of about 1 to 2 mm.

6. The construction of claim 1, wherein the face fabric tape is comprised of polyester and elastane.

7. The construction of claim 1, wherein the stretch adhesive is thermoplastic polyurethane.

8. The construction of claim 1, wherein the at least one joint seam is a plurality of joint seams.

9. A garment, comprising at least one of the waterproof softshell construction of claim 1.

10. The garment of claim 9, wherein each seam of the garment is a joint seam formed by sonic welding.

11. A method of preparing a waterproof softshell construction, comprising the steps of:
joining a face fabric layer, a laminate layer, and a backer layer at a joint seam using a sonic welder; and
attaching face fabric tape to the joint seam using stretch adhesive.

12. The method of claim 11, wherein the face fabric layer is a polyester nylon elastine stretch fabric.

13. The method of claim 11, wherein the laminate layer is a stretch laminate.

14. The method of claim 11, wherein the backer layer is a tricot warp knit backer.

15. The method of claim 11, wherein the joint seam has a thickness of about 1 to 2 mm.

16. The construction of claim 11, wherein the face fabric tape is comprised of polyester and elastane.

17. The construction of claim 11, wherein the stretch adhesive is thermoplastic polyurethane.

18. A waterproof softshell construction prepared by a process comprising the steps of:
joining a face fabric layer, a laminate layer, and a backer layer at a joint seam by sonic welding; and
attaching face fabric tape to the joint seam using stretch adhesive.

19. A garment, comprising at least one of the waterproof softshell construction of claim 18.

20. The garment of claim 19, wherein each seam of the garment is a joint seam formed by sonic welding.
